(19) United States
(12) Patent Application Publication
(10) Pub. No.: US 2010/0186208 A1
(43) Pub. Date: Jul. 29, 2010

(54) COMPRESSION FERRULE REMOVAL TOOL

(76) Inventor: ADAM D. ABRAMS, Mission Viejo, CA (US)

Correspondence Address: Adam D. Abrams, 26556 Oso Rojo, Mission Viejo, CA, 92692, US

(21) Appl. No.: 12/359,917

(22) Filed: Jan. 26, 2009

(51) Int. Cl. B25B 27/02

(52) U.S. Cl. 29/244

(57) ABSTRACT

A ferrule extraction tool for sliding a ferrule off of a pipe is disclosed. The tool may be operated with one hand such that a plumber may operate the tool in hard to reach areas. The tool has an actuator which pushes a yoke. The yoke engages a smooth rod and traverses a ram forward upon actuation of an actuator. Upon release of the actuator, the yoke releases the smooth rod and is traversed back to a retracted position via a spring force. A brake prevents rearward traversal of the rod as the yoke is traversed in a rearward direction. To reset the tool after removing the ferrule from the pipe, the operator may release the brake such that the operator may traverse the rod and the ram back to the retracted position.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates to a plumbing tool.

Homes, businesses and other structures are plumbed with a system of pipes to deliver water and other fluids to various locations within the structure. By way of example and not limitation, pipes may be routed from a city supply line to the kitchen sink, bathroom and also the backyard to provide easy and convenient access to water. The pipe system typically comprises a series of smaller section pipes that are interconnected to each other to route the water underground, through walls and ultimately to the desired location (e.g., kitchen, bathroom, backyard, etc.). The pipe system may also include one or more shutoff valves within the home such that a plumber may stop flow of water through the pipe system at a location upstream of a problem but downstream of the city's supply line. By way of example and not limitation, a shutoff valve may be located under a kitchen sink such that a plumber can shut off the flow of water to work on the kitchen faucet or other plumbing components downstream of the shutoff valve yet the rest of the house will have running water.

In order to connect some shutoff valves to a copper pipe, a compression ferrule type fitting may be used. The ferrule fitting typically utilizes a brass circular band. An inner diameter of the brass band is substantially equal to the outer diameter of the pipe. Opposed distal end portions of the ferrule may have a frusto conical configuration. To install the shut off valve, a nut of the shutoff valve is placed over the pipe followed by the compression ferrule. The nut is tightened onto a threaded portion of the shutoff valve. As the nut is tightened onto the shut off valve, the shutoff valve nut compresses the ferrule against the pipe and the inner edge of the shutoff valve to form a waterproof seal therebetween.

Unfortunately, after installation, the ferrule may be difficult to remove due to the compression. Additionally, over a period of time, the ferrule may be mechanically attached to the pipe. During maintenance of the pipe system, it is sometimes necessary to change out the shut off valve including the ferrule. To this end, plumbers may cut off the ferrule from the distal end portion of the pipe. However, cutting the distal end portion of the pipe can only be done when the shortened pipe can be reattached to the shutoff valve and the pipe system.

Devices exist to remove the ferrule from the pipe. For example, one such device is disclosed in U.S. Pat. No. 4,672,731 ('731 Patent). As can be seen, this is a two handed device. To operate the device, the pipe with ferrule is initially disposed behind a base. The operator must hold the main portion of the tool while turning the handle to traverse the plug forward until the plug contacts the distal end of the pipe and the ferrule attached to the pipe contacts the base. The operator continues to turn the handle while holding the main portion of the tool until the pipe is dislodged from the ferrule. The tool is cumbersome to operate because it requires the plumber or operator to use both hands to operate the tool. Unfortunately, in certain hard to reach places, the operator or plumber may have to contort his/her body in many awkward positions while attempting to operate the two handed tool around objects such as P-traps and drain pipes. Another deficiency in relation to the device disclosed in the '731 Patent is that the tool is not aligned to the pipe once the extraction process is started. The plug appears to merely rest on the distal end of the pipe. Additionally, the plug is traversed forward by rotating the threaded rod. Unfortunately, there must be sufficient space to turn the handle of the tool. Also, upon contact of the plug with the pipe, the plug remains stationary while the rod continues to rotate. The device disclosed in the '731 Patent provides for turning groove configuration to allow the rod to rotate while the plug does not rotate with a groove and tongue configuration. However, after repeated use, the groove or tongue (i.e., pin) may become worn and require replacement.

Another deficiency in relation to other ferrule extraction devices is that those devices may require an adapter nut to thread into the shutoff valve nut. For example, one such device is shown in U.S. Pat. No. 6,904,660. This device is cumbersome to use based on a contention that the operator must thread the adapter nut onto the shutoff valve nut. In certain situations, the location of the shutoff valve may prevent or make difficult the engagement of the adapter nut to the shutoff valve nut.

### BRIEF SUMMARY

The tool described herein addresses the deficiencies identified above, identified below and those that are known in the art. The tool may be operated with one hand such that the operator may more easily use the tool to remove ferrules from pipes that are located in hard to reach locations. The tool may be operated by either the left hand or the right hand. In the event that the shut off valve is located adjacent pipes and other objects, the tool may be positioned at any orientation 360 degrees to avoid the pipe and/or objects. The operator needs no hand support. Also, the tool can be operated with the operator outside a vanity or cabinet.

To initiate the process of removing a ferrule from a pipe, a ram of the tool is traversed to a retracted position within a cavity of the tool. The distal end portion of the pipe is positioned within the cavity of the tool with the pipe extending from a notch of the tool. The ferrule and a nut are also positioned within the cavity and disposed adjacent a front base plate of the tool. The notch width is greater than the outer diameter of the pipe but smaller than the outer diameter of the nut. Accordingly, the distal end portion of the pipe, the ferrule and the nut slides into the cavity. The tool does not engage with the threads of the shutoff valve nut.

The ram is traversed forward until a head of the ram is received within the pipe. The size of the head and the inner diameter of the pipe may snugly fit with each other such that the pipe is capable of supporting the tool if the operator releases the handle of the tool. The ram is traversed forward until a shoulder of the ram contacts a distal end of the pipe. The ram is traversed forward until the front base plate contacts the nut. At this point, the ram may be traversed forward to slide the ferrule and nut off of the pipe. The shoulder of the ram contacts the distal end of the pipe while the front base plate pushes the nut and ferrule in the opposite direction off of the pipe.

The mechanism for traversing the ram forward may comprise a smooth rod attached to the ram and a yoke. The yoke is capable of frictionally engaging the smooth rod to push the rod and ram forward and release the smooth rod upon rearward traversal. More particularly, the tool may comprise a handle having a grip and an actuator. The actuator is operative to push the yoke forward. A spring is disposed in front of the yoke to push the yoke backwards upon release of the actuator. A brake in an engaged position permits forward traversal of the smooth rod but not backward traversal.

During operation, the user may squeeze the actuator to push the yoke forward. Since the actuator pushes the yoke forward on the lower portion of the yoke, the yoke is tilted such that a front lower edge and a rear upper edge of the yoke frictionally engage the smooth rod. The actuator continues to push the yoke forward to traverse the smooth rod and the attached ram in the forward direction. When the actuator is fully depressed, the yoke and actuator must be reset. To this end, the actuator is released upon which the spring pushes the yoke to the rearward position and the handle to the reset position. When the yoke is traversed backward, the rod maintains its position under the braking force of the brake. The brake permits forward traversal of the rod but not rearward traversal of the rod unless the brake is released. The actuator is repeatedly squeezed and released until the front base plate slides the ferrule and nut off of the pipe. After the ferrule and nut are slid off of the pipe, the ferrule and nut may be disposed about the smooth rod and the ram. To discharge the used ferrule and nut and reset the tool, the operator depresses the brake to release the braking force off of the smooth rod. The operator may then traverse the ram back into the cavity to the retracted position with the pull knob at the rear of the rod. This action allows the nut and ferrule to be discharged from the tool and sets up the tool for subsequent use.

The brake in its normal position applies a braking force to the smooth rod permitting forward but not rearward traversal of the rod. To this end, the brake has an aperture through which the rod is disposed. In an engaged position, an upper front edge of the aperture and a lower rear edge of the aperture frictionally engages the rod.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a compression ferrule removal tool;

FIG. 2 is a cross sectional view of the tool shown in FIG. 1 with a ram in a retracted position and an actuator;

FIG. 3 is a cross sectional view of the tool shown in FIG. 1 with the ram being pushed forward and the actuator at a depressed position;

FIG. 4 illustrates the ferrule and a nut removed from a pipe;

FIG. 5 is an exploded view of the tool shown in FIG. 1;

FIG. 6 is a front perspective view of a yoke shown in FIGS. 2 and 3; and

FIG. 7 is a rear perspective view of the yoke shown in FIGS. 2 and 3.

### DETAILED DESCRIPTION

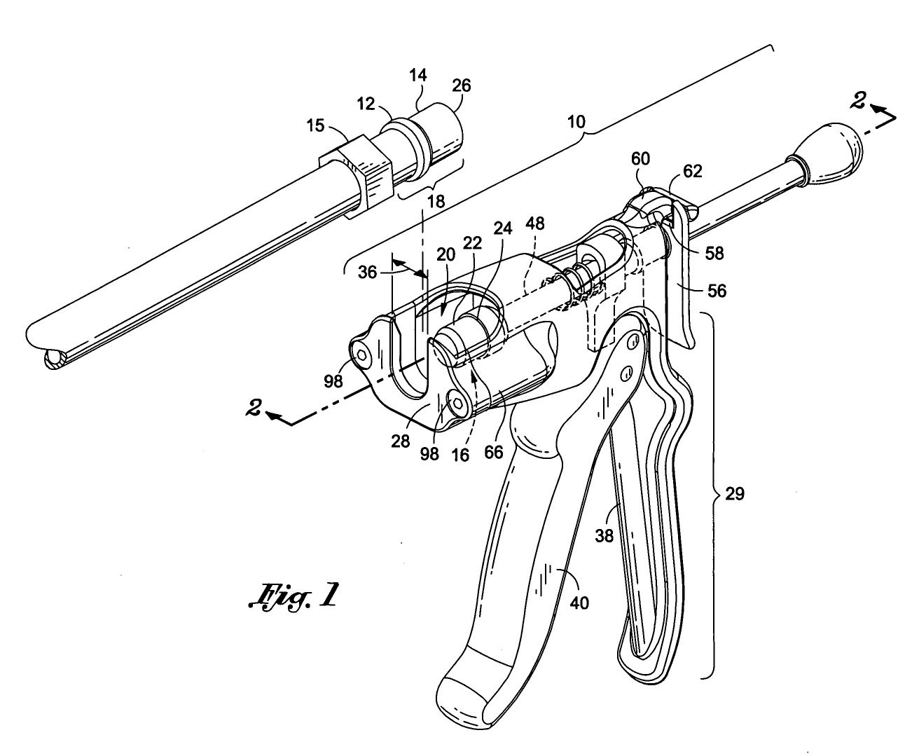

Referring now to the figures, a tool 10 (see FIG. 1) for removing a ferrule 12 and nut 15 from a pipe 14 is shown. The tool 10 may be operated with one hand to remove the ferrule 12 and nut 15 from the pipe 14 such that the operator or plumber may use the device to remove ferrules 12 and nuts 15 located at hard to reach places. For example, if the ferrule 12 and the pipe 14 are located under the kitchen sink, then the operator may contort his/her body with the operator outside the vanity while operating the tool 10 with one hand to remove the ferrule 12 from the pipe 14.

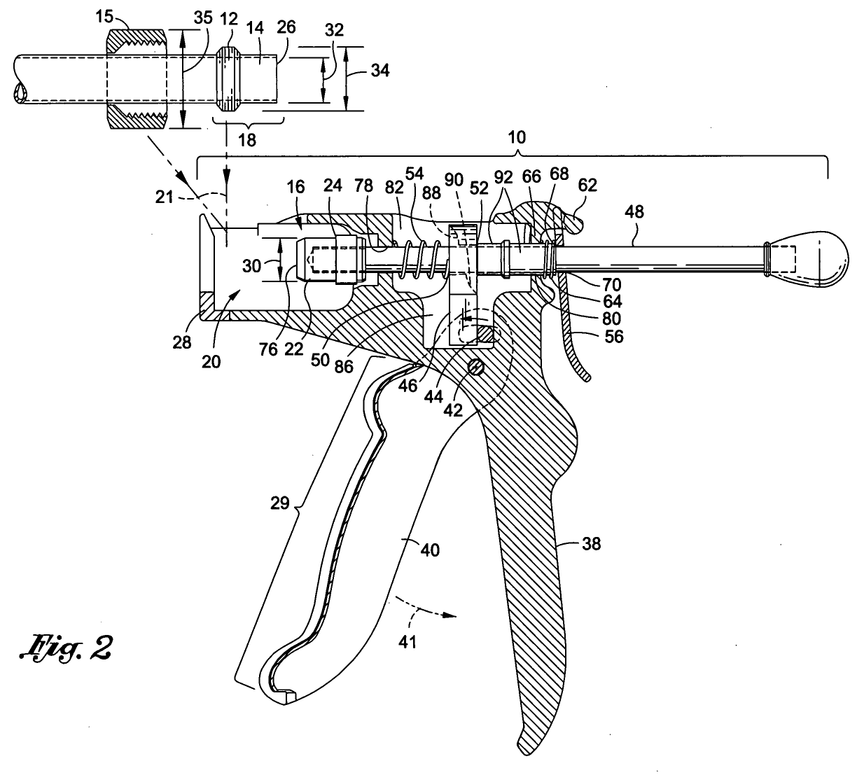

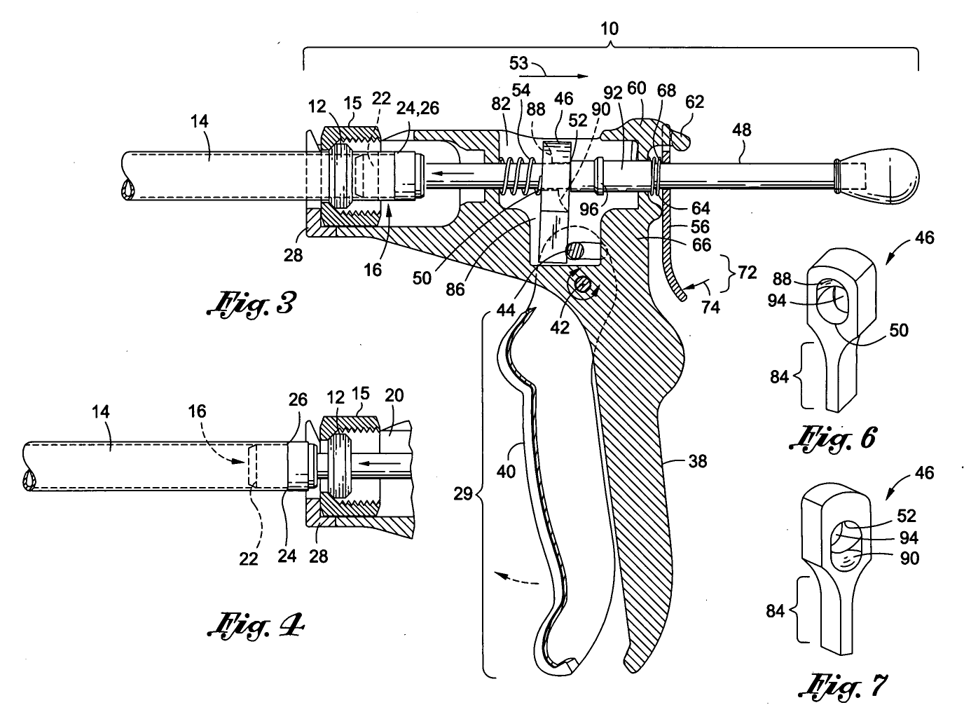

More particularly, the ram 16 of the tool 10 is initially disposed at the retracted position, as shown in FIG. 1. The distal end portion 18 of the pipe 14 along with the ferrule 12 and nut 15 are positioned within a cavity 20 of the tool 10, as shown by phantom line 21 in FIG. 2. The distal end portion 18 of the pipe 14, the ferrule 12 and the nut 15 slide into the cavity 20. The ram 16 is aligned to the pipe 14 and traversed toward the pipe 14. As shown in FIG. 3, as the ram 16 is pushed forward, a head 22 of the ram 16 is disposed within the pipe 14. The head 22 of the ram 16 preferably slides into the interior of the pipe 14. A shoulder 24 (see FIGS. 1 and 2) of the ram 16 contacts the distal end 26 (see FIGS. 1 and 2) of the pipe 14. As the ram 16 is traversed forward, a front base plate 28 contacts the nut 15. As the ram continues its forward movement, the front base plate 28 pushes the nut and ferrule 12 off of the pipe 14, as shown in FIG. 4. The ram 16 is pushed forward by actuating the one handed handle 29. In this manner, a plumber or other personnel may easily reach hard to reach areas. By way of example and not limitation, the pipe 14 and ferrule 12 may be located under the sink, behind a toilet bowl, between a wall or other hard to reach location. The tool 10 may be manipulated with one hand to reach those hard to reach locations and remove the ferrule 12 from the pipe 14.

Referring now to FIG. 2, a cross section of the tool 10 is shown. Initially, the ram 16 is at the retracted position. The distal end portion 18 of the pipe 14, the ferrule 12 and the nut 15 are disposed within the cavity 20. An outer diameter 30 of the head 22 may be less than an inner diameter 32 of the pipe 14. The outer diameter 35 (see FIG. 2) of the nut 15 is greater than a notch width 36 (see FIGS. 1 and 5) formed in the front base plate 28 (see FIGS. 1 and 5). The ram 16 is pushed forward via actuation of an actuator 40 in the direction of arrow 41 (see FIG. 2). The head 22 of the ram 16 is disposed within the pipe 14 (see FIG. 3). Also, the shoulder 24 of the ram 16 contacts the distal end 26 of the pipe 14. When the front base plate 28 contacts the nut 15, the ram 16 and front base plate 28 holds the ferrule 12 and the nut 15 within the cavity 20. The actuator 40 is actuated until the ferrule 12 and the nut 15 are slid entirely off of the pipe 14, as shown in FIG. 4.

The head 22 of the ram 16 may snugly fit within the inner diameter 32 (see FIG. 2) of the pipe 14. In this manner, the snug fit between these components 22, 32 aligns the tool 10 to the pipe 14. The ram 16 does not merely rest upon the distal end 26 of the pipe 14. Rather, the ram 16, and more particularly, the head portion 22 of the ram 16 interacts with the pipe 14 such that once the head 22 of the ram 16 is disposed within the pipe 14, the operator may release the tool 10 while the pipe 14 supports the tool 10.

To push or traverse the ram 16 forward, the handle 29 is actuated. In particular, the handle 29 may comprise a grip 38 and the actuator 40. The grip 38 is disposed within the palm of the plumber or operator. The fingers of the plumber are wrapped around the actuator 40. The plumber may squeeze the actuator 40 toward the grip 38 which traverses the ram 16 in a forward direction. More particularly, as the actuator 40 is squeezed toward the grip 38, the actuator 40 rotates about pivot point 42 (see FIG. 3). The actuator 40 causes a pin 44 to push a yoke 46 forward. During this forward motion of the pin 44 and the yoke 46, the yoke 46 is tilted (see FIG. 3) and wedged against a rod 48. The lower front edge 50 and the upper rear edge 52 are wedged into the rod 48 and thereby placed in frictional engagement therewith. As the pin 44 is moved forward, the yoke 46 and rod 48 are also moved forward. At the end of the actuator's stroke, the yoke 46 is at the fully forward position, as shown in FIG. 3.

Upon release of the actuator 40, the center spring 54 pushes the yoke 46 to the rear of the tool 10, as shown by arrow 53. Additionally, the yoke 46 pushes the pin 44 to the rear of the tool 10 and rotates the actuator 40 back to the position shown in FIG. 2. The brake 56 holds the position of the rod 48 upon release of the actuator 40 such that the ram 16 does not move backward upon release of the actuator 40.

When the yoke 46 moves back to the rear of the tool 10, the rod 48 does not traverse backward. A brake 56 prevents backward traversal of the rod 48. More particularly, as shown in FIG. 5, the brake 56 may have a notch 58 which receives a tang 60. The brake 56 is disposed in front of outwardly protruding support member 62. A release spring 64 is disposed between the brake 56 and a body 66 of the tool 10. The release spring 64 pushes the brake 56 to a skewed position (see FIG. 2). In this position, the upper front edge 68 and the lower rear edge 70 of the brake 56 are wedged into the rod 48 and prevent any rearward traversal or movement of the rod 48 when the actuator 40 is released. The user or plumber can cycle the actuator 40 to incrementally push or move the ram 16 in the forward direction until the nut 15 and ferrule 12 are entirely slid off of the pipe 14. It is also contemplated that other means known in the art or developed in the future for biasing the brake 56 toward skewed angle may be implemented such that the upper front edge 68 and the lower rear edge 70 of the brake 56 frictionally engages the smooth rod 48.

After the nut and ferrule are slid off of the pipe 14 (see FIG. 4), the brake 56 is released to permit the rod 48 to move backward and retract the ram 16 back into the cavity 20 in the retracted position (see FIG. 1). To this end, as shown in FIG. 3, the lower distal end portion 72 is pushed forward in direction of arrow 74. Pushing the lower distal end portion 72 of the brake forward releases the upper front edge 68 and the lower rear edge 70 from the rod 48 such that the user can pull the rod 48 backward with his/her thumb and forefinger to traverse the ram 16 back into the cavity 20 to the retracted position while discharging the nut 15 and ferrule 12 from the ram 16 and rod 48. The user releases the brake 56. At this point, the tool 10 is ready for reuse.

The body 66 of the tool 10 may have two alignment holes 78, 80 (see FIG. 2). The alignment holes 78, 80 maintain alignment of the rod 48 as the ram 16 is traversed to the extended position then reset back to the retracted position.

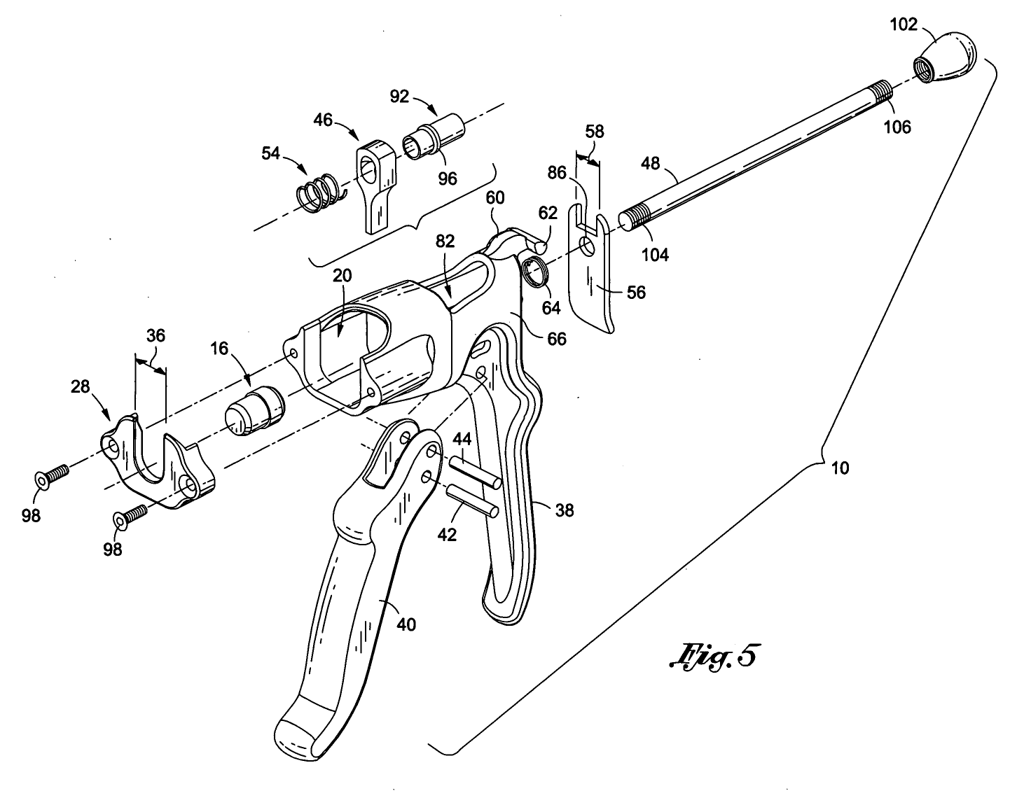

The yoke 46 may be disposed within a second cavity 82 (see FIGS. 2, 3 and 5) of the body 66. The yoke 46 may have a T-shaped configuration as shown in FIGS. 6 and 7. The second cavity 82 may have a corresponding T-shaped cross sectional configuration to permit the yoke 46 to move forward upon actuation of the actuator 40 and move backward upon release of the actuator 40 via rearward biasing of the yoke 46 by the spring 54. As shown in FIGS. 6 and 7, the yoke 46 may have a lower extending leg portion 84 which slides within a channel 86 (see FIGS. 2 and 3) of the second cavity 82 in the body 66. Moreover, as shown in FIGS. 2, 3, and 6, the front side of the yoke 46 may have a recessed area 88. Also, the backside of the yoke 46 may have a recessed area 90. The recessed areas 88, 90 allow the rod 48 to slide within the yoke 46 upon release of the actuator 40 and/or actuation of the actuator 40.

A sleeve 92 (see FIGS. 3 and 5) may be disposed behind the yoke 46. The sleeve 92 may slide back and forth within the aperture 80 during cycling of the actuator 40. The rod 48 slides within the sleeve 92. The sleeve 92 may additionally have a flange 96 (see FIGS. 3 and 5). The outer diameter of the flange 96 may be greater than the inner diameter of the aperture 80. The length of the sleeve 92 may be sized to align the yoke 46 in an upright direction to the rod 48 when the actuator 40 is positioned as shown in FIG. 2. In this manner, the rod 48 is allowed to move backward upon depression of the portion 72 (see FIG. 2) of the brake 56 in the direction of arrow 74 to reset the tool 10.

In an aspect of the tool 10, different size rams 16 and front base plates 28 may be provided such that the rams 16 and base plates 28 may be changed out to fit the particular ferrule 12 and pipe 14. In particular, the front base plate 28 may be removably attached to the body 66 of the tool 10. By way of example but not limitation, as shown in FIG. 5, the front base plate 28 may be attached to the body 66 with screws 98. It is also contemplated that the front base plate 28 may be removably attachable to the body 66 with a quick release mechanism as is commonly known in the art such that the operator may quickly change out the front base plate 28 depending on the size of the pipe 14 and ferrule 12. Additionally, the ram 16 is removably attachable to the rod 48. By way of example but not limitation, the distal end portion of the rod 48 may have threads 104 (see FIG. 5) which are threadably engagable to threads formed in the ram 16, as shown in FIG. 2. Preferably, the outer diameter 30 of the head 22 of the ram 16 is equal to or slightly less than the inner diameter 32 of the pipe 14. The outer diameter 100 of the shoulder 24 is preferably less than the outer diameter of the pipe 14 but greater than the inner diameter 32 of the pipe 14. In this manner, the nut 15 and the ferrule 12 which are disposed about the pipe 14 can be slid off of the pipe 14. The notch width 36 is preferably greater than the outer diameter of the pipe 14 but smaller than the outer diameter 35 of the nut 15. The appropriate ram 16 and front base plate 28 may be selected based on the pipe 14 and ferrule 12 combination.

At the rear of the tool 10, a rod cap 102 may be attached to the rod 48. By way of example but not limitation, the distal end portion of the rod 48 may have threads 106 (see FIG. 5). The rod cap 102 may receive the threads 106 on the distal end portion of the rod 48 to secure the rod cap 102 to the rod 48, as shown in FIGS. 2 and 5. The rod cap 102 prevents the rod 48 from proceeding too far forward such that the rod 48 is dislodged from the brake 56. Additionally, the operator may grasp the rod cap 102 to pull the smooth rod backward to reset the tool for subsequent use.

The mechanism for driving the pushrod 48 forward incorporates a smooth rod 48. The outside surface of the smooth rod 48 is smooth such that the smooth rod 48 may slide through the yoke and the brake 56 and be gripped by either the yoke and the brake at the appropriate time as the actuator 40 is cycled. However, it is also contemplated that the mechanism for driving the pushrod 48 forward may be other types of mechanism such as a ratchet type mechanism, pneumatic, screw battery operated, etc.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A tool for removing a compression ferrule seized on a pipe and the stop valve nut, the tool comprising:
a base plate with a notch having an inner dimension, the inner dimension of the notch being larger than an outer diameter of the pipe and smaller than an outer diameter of the nut;
a body defining a proximal portion and a distal portion, the base plate being disposed adjacent the distal portion of the body;
a shoulder traversable from the proximal portion of the body to the distal portion of the body and through the notch of the base plate, the shoulder having an outer diameter greater than the inner diameter of the pipe and smaller than the outer diameter of the pipe for permitting the shoulder to pass through the compression ferrule as the compression ferrule is slid off of the pipe;
a one handed grip attached to the body for holding the tool in a plurality of orientations such that an operator is capable of utilizing the tool to remove compression ferrules from pipes in hard to reach locations;
a trigger attached to the grip wherein actuation of the trigger translates the shoulder from the proximal portion to the distal portion for sliding the compression ferrule off of the pipe.

2. The tool of claim 1 further comprising a head attached to the shoulder wherein the head and shoulder collectively forms a ram, the head having an outer diameter smaller than an inner diameter of the pipe for aligning the tool to the pipe.

3. The tool of claim 1 further comprising a rod linearly traverseable within the body, the rod defining a distal end portion and a proximal end portion, the distal end portion of the rod being fixedly attached to the shoulder.

4. The tool of claim 1 further comprising:
a smooth rod linearly traversable within the body;
a yoke having an aperture with the smooth rod slideably disposed therein, the yoke defining a first side lower edge and a second side upper edge, the first side lower edge and the second side upper edge frictionally engaging the smooth rod as the trigger is actuated.

5. The tool of claim 4 wherein the trigger moves the yoke toward a forward direction when the trigger is actuated.

6. The tool of claim 4 wherein the first side of the yoke has a first side recessed area and the second side of the yoke has a second side recessed area.

7. The tool of claim 4 wherein a first side of the yoke has an upper recessed area and a second side of the yoke has a lower recessed area.

8. A method of removing a ferrule from a pipe with a tool, the method comprising the steps of:
disposing a distal end portion of a pipe, a ferrule seized on the distal end of the pipe and a nut behind a base plate of an extractor tool;
disposing the pipe within a notch of the base plate of the extractor tool;
with one hand, actuating a handle to push a rod of the extractor tool toward the base plate;
contacting a ram attached to the rod to a distal end of the pipe;
contacting the nut directly against the base plate;
sliding the ferrule and the nut off of the pipe;
releasing a brake of the tool to traverse the ram back to a retracted position; and
removing the ferrule and nut from the tool.

9. The method of claim 8 wherein the pushing step comprising squeezing a handle of the tool.

10. The method of claim 9 wherein the squeezing step comprising traversing an actuator toward a grip.

11. The method of claim 8 wherein the releasing step comprising pushing a lower distal end portion of a brake member.
